(19) United States
(12) Patent Application Publication
(10) Pub. No.: US 2022/0386350 A1
(43) Pub. Date: Dec. 1, 2022

(54) TERMINAL AND COMMUNICATION METHOD

(71) Applicant: NTT DOCOMO, INC., Tokyo (JP)

(72) Inventors: Daiki Takeda, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 17/762,268

(22) PCT Filed: Sep. 25, 2019
(86) PCT No.: PCT/JP2019/037705

§ 371 Date: Mar. 21, 2022

(51) Int. Cl. H04W 72/12; H04L 5/00

(52) U.S. Cl. CPC H04W 72/1289; H04L 5/0092; H04W 72/1215

(57) ABSTRACT

A terminal includes a receiving unit that receives configuration information regarding puncturing of a downlink subcarrier of a first Radio Access Technology (RAT) among a plurality of supported RATs; and a control unit that configures a number of one or more outlying subcarriers of the first RAT and a position of the one or more outlying subcarriers of the first RAT in a frequency domain based on the configuration information and configures a reception frequency band of a downlink carrier of the first RAT by puncturing a frequency band of the one or more outlying subcarriers.

### TECHNICAL FIELD

The present invention relates to a terminal and a communication method in a radio communication system.

### BACKGROUND ART

Long Term Evolution (LTE)-based IoT (LTE-IoT), i.e., enhanced Machine Type Communication (eMTC) and Narrow Band Internet of Things (NB-IoT) are assumed to be operated in an LTE frequency band. In the future, for example, when LTE is replaced with New Radio (NR), NB-IoT may be operated on NR-based enhanced Mobile Broadband (eMBB), and eMTC may be operated on NR.

Regarding LTE-IoT of 3GPP, discussions have been made on a scenario in which LTE-IoT and NR described above coexist. It is basically assumed that the coexistence of LTE-IoT and NR can be supported by using the resource reservation supported by NR.

### PRIOR ART DOCUMENT

### Non-Patent Document

Non-Patent Document 1: 3GPP TSG RAN WG1 Meeting #98, R1-1907973, Prague, Czech, Rep, 26-30, Aug. 2019

### SUMMARY OF THE INVENTION

### Problem to be Solved by the Invention

In order to enhance frequency utilization efficiency, it has been studied to puncture an outlying subcarrier. In a case of puncturing an outlying subcarrier, it is assumed that a base station transmits, to a terminal, a notification of information regarding the outlying subcarrier to be punctured by using higher layer signaling. In this case, it is necessary to clarify the content of the notification transmitted by higher layer signaling.

### Means for Solving the Problem

According to an aspect of the present invention, there is provided a terminal including a receiving unit that receives configuration information regarding puncturing of a downlink subcarrier of a first Radio Access Technology (RAT) among a plurality of supported RATs; and a control unit that configures a number of one or more outlying subcarriers of the first RAT and a position of the one or more outlying subcarriers of the first RAT in a frequency domain based on the configuration information and configures a reception frequency band of a downlink carrier of the first RAT by puncturing a frequency band of the one or more outlying subcarriers.

### Advantage of the Invention

According to an embodiment, in a case where information regarding an outlying subcarrier to be punctured is to be transmitted by higher layer signaling, the content of the information is clarified.

### BRIEF DESCRIPTION OF DRAWINGS

FIG. 1 is a diagram illustrating a configuration of a communication system according to an embodiment.

FIG. 2 is a diagram illustrating an example of an arrangement of an eMTC carrier and/or an NB-IoT carrier.

FIG. 3 is a diagram illustrating an example in which a grid of eMTC PRBs is shifted from a grid of NR PRBs.

FIG. 4 is a diagram illustrating an example of an outlying subcarrier of eMTC.

FIG. 5 is a diagram illustrating an example of puncturing the outlying subcarrier of eMTC.

FIG. 6 is a diagram illustrating another example of outlying subcarriers of eMTC.

FIG. 7 is a diagram illustrating an example of puncturing the two outlying subcarriers of eMTC.

FIG. 8 is a diagram illustrating another example of an outlying subcarrier of eMTC.

FIG. 9 is a diagram illustrating an example of puncturing the outlying subcarrier of eMTC.

FIG. 10 is a diagram illustrating another example of puncturing an outlying subcarrier of eMTC.

FIG. 11 is a diagram illustrating another example of an outlying subcarrier of eMTC.

FIG. 12 is a diagram illustrating an example of a functional configuration of a base station.

FIG. 13 is a diagram illustrating an example of a functional configuration of a terminal.

FIG. 14 is a diagram illustrating an example of a hardware configuration of a terminal and a base station.

### EMBODIMENTS OF THE INVENTION

In the following, embodiments of the present invention are described with reference to the drawings. The embodiments described below are merely examples, and embodiments to which the present invention is applied are not limited to the following embodiments.

The embodiments of the present invention described below use the terms Synchronization Signal (SS), Primary SS (PSS), Secondary SS (SSS), Physical Broadcast channel (PBCH), Physical Random Access channel (PRACH), and the like, used in existing LTE. This is for convenience of descriptions and similar signals and functions may be referred to by other names. The above-described terms in NR correspond to NR-SS, NR-PSS, NR-SSS, NR-PBCH, NR-PRACH, and the like. However, even if a signal is used for NR, it is not necessarily specified as “NR-.”

In the embodiments of the present invention, a duplex method may be a Time Division Duplex (TDD) method, a Frequency Division Duplex (FDD) method, or any other method (e.g., Flexible Duplex).

Furthermore, in the embodiments of the present invention, to configure a radio parameter or the like may be to pre-configure a predetermined value, or to configure a radio parameter transmitted from a base station 10 or a terminal 20.

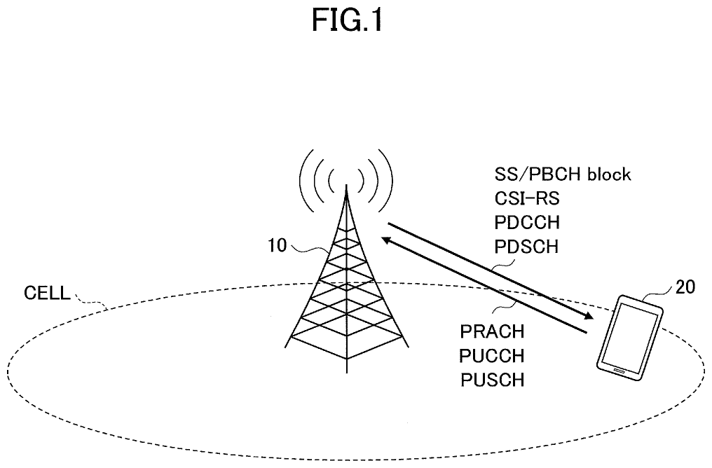

FIG. 1 is a diagram illustrating a radio communication system according to an embodiment of the present invention. The radio communication system in an embodiment of the present invention includes a base station 10 and a terminal 20, as illustrated in FIG. 1. In FIG. 1, one base station 10 and one terminal 20 are illustrated. However, this is an example and there may be a plurality of base stations 10 and a plurality of terminals 20.

The base station 10 is a communication device that provides one or more cells and that performs radio communication with the terminal 20. Physical resources of a radio signal are defined in a time domain and a frequency domain, the time domain may be defined by a number of OFDM symbols, and the frequency domain may be defined by a number of sub-carriers or a number of resource blocks. The base station 10 transmits synchronization signals and system information to the terminal 20. The synchronization signals are, for example, NR-PSS and NR-SSS. A part of the system information is transmitted, for example, by NR-PBCH, and is also called broadcast information. The synchronization signal and broadcast information may be periodically transmitted as an SS block (SS/PBCH block) formed of a predetermined number of OFDM symbols. For example, the base station 10 transmits a control signal or data in Downlink (DL) to the terminal 20 and receives a control signal or data in Uplink (UL) from the terminal 20. Both the base station 10 and the terminal 20 are capable of beam forming to transmit and receive signals. For example, as illustrated in FIG. 1, a reference signal transmitted from the base station 10 includes Channel State Information Reference Signal (CSI-RS) and a channel transmitted from the base station 10 includes a Physical Downlink Control Channel (PDCCH) and a Physical Downlink Shared Channel(PDSCH).

The terminal 20 is a communication device with a radio communication function, such as a smartphone, a cellular phone, a tablet, a wearable terminal, and a communication module for Machine-to-Machine (M2M). The terminal 20 utilizes various communication services provided by a radio communication system by receiving control signals or data from the base station 10 in DL and transmitting control signals or data in UL to the base station 10. For example, as illustrated in FIG. 1, channels transmitted from the terminal 20 include Physical Uplink Control Channel (PUCCH) and Physical Uplink Shared Channel (PUCCH).

In regard to a communication system for Internet of Things (IoT) that enables low power consumption and low cost, in 3GPP, enhanced Machine Type Communication (eMTC) and Narrow Band Internet of Things (NB-IoT) have been studied.

The eMTC is a communication technology that supports low-speed to medium-speed movement and supports relatively large data. The NB-IoT is a communication technology optimized for communication of a small amount of data in which no movement during communication is assumed.

Long Term Evolution (LTE)-based Iot (LTE-IoT), that is, enhanced Machine Type Communication (eMTC) and Narrow Band Internet of Things (NB-IoT) are assumed to be operated in an LTE frequency band. In the future, for example, when LTE is replaced with New Radio (NR), NB-IoT may be operated on NR-based enhanced Mobile Broadband (eMBB), and eMTC may be operated on NR.

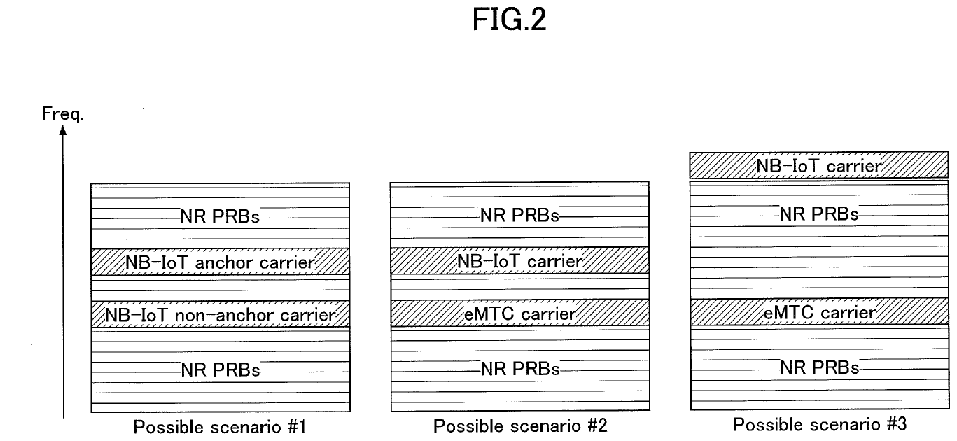

FIG. 2 is a diagram illustrating an example of arrangements of eMTC carriers and/or NB-IoT carriers. As illustrated in FIG. 2, a scenario in which eMTC carriers and/or NB-IoT carriers and NR carriers are arranged, that is, a scenario in which eMTC/NB-IoT and NR coexist is assumed. In scenario #1 illustrated in FIG. 2, NB-IoT carriers including an anchor carrier and a non-anchor carrier and a PRB (Physical Resource Block) of NR carriers are arranged adjacent to each other. In scenario #2 illustrated in FIG. 2, eMTC carriers and the PRB of NR carriers are arranged adjacent to each other, and NB-IoT carriers and the PRB of NR carriers are arranged adjacent to each other. In scenario #3 illustrated in FIG. 2, eMTC carriers and the PRB of NR carriers are arranged adjacent to each other, and NB-IoT carriers arranged in the guard band and the PRB of NR carriers are arranged adjacent to each other. As in these scenarios, it is assumed that carriers used for eMTC and/or NB-IoT and the PRB of carriers used for NR coexist to be adjacent to each other.

In the discussion of 3GPP LTE-IoT, a scenario in which LTE-IoT and NR coexist as described above is under discussion. By using resource reservation supported by NR, basically, the coexistence of LTE-IoT and NR has already been supported.

For example, because an NB-IoT carrier has a bandwidth of one PRB, it is possible to arrange NB-IoT carriers by constantly allocating a band for one PRB to NB-IoT by using the resource reservation function supported by NR, that is, by reserving the band for the one PRB so as not to be used in NR.

Similarly, for example, a carrier of eMTC has a bandwidth of six PRBs. Accordingly, it is possible to arrange eMTC carriers by reserving a bandwidth of six PRBs so as not to be used in NR by using the resource reservation function supported by NR.

(Outlying Subcarrier)

In OFDM of LTE, it is assumed that the DC subcarrier is not used for communication in order to reduce the influence of the Direct Current (DC) offset of the receiver, which causes a problem during data demodulation. One PRB of eMTC includes 12 subcarriers. However, when a DC subcarrier is included in one PRB and the DC subcarrier is not used for communication, a case is assumed in which one PRB of eMTC is occupied by 13 subcarriers including the central DC subcarrier, which is not used for communication. In contrast, because the DC subcarrier is not defined in NR, it is considered that one PRB of NR includes 12 subcarriers.

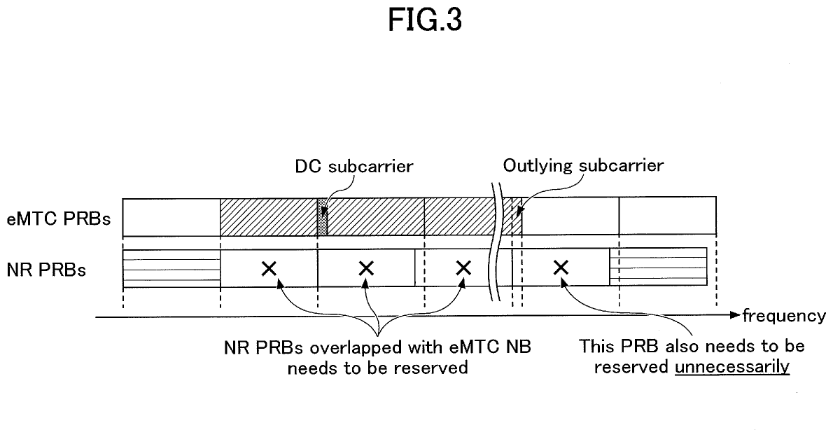

Accordingly, as illustrated in FIG. 3, when eMTC PRBs and NR PRBs are arranged in alignment with each other, it is assumed that there is a case in which a grid of eMTC PRBs is shifted from a grid of NR PRBs since there is a DC subcarrier in the eMTC.

In this case, assuming that the normal eMTC carrier bandwidth is six PRBs, the eMTC carrier bandwidth when the DC subcarrier is included is a bandwidth of six PRBs+one subcarrier. In the eMTC, as illustrated in FIG. 3, when the bandwidth for six PRBs+one subcarrier is fixedly used, seven PRBs should be reserved instead of six PRBs on the NR side. Accordingly, it is likely that the frequency utilization efficiency will be reduced. That is, because the outlying subcarrier illustrated in FIG. 3 is present, it is assumed that one PRB of NR partially overlapping the outlying subcarrier in the frequency domain is to be reserved, and it has been pointed out that it is likely that the frequency utilization efficiency will be reduced.

When LTE-Machine Type Communication (MTC) and NR coexist as a Work Item for eMTC enhancement of Release 16 of 3GPP, it has been studied to reduce the number of NR subcarriers that need to be reserved by puncturing the subcarriers of the eMTC, that is, by not transmitting a modulation signal that should originally be transmitted.

At the RAN1 meeting, the following matters have been discussed.

Whether LTE-MTC DL (Downlink) subcarrier puncturing should be applied for each scheduled transmission, each narrow band, and each system bandwidth.

Whether DL subcarriers on both sides of the transmission frequency band should be punctured.

Setting the maximum number of LTE-MTC DL subcarriers that can be deleted to 2.

Configuring the (maximum) number of subcarriers to be deleted and their positions by SIB or UE-specific Radio Resource Control (RRC) signaling. Whether to allow overwriting or modifying of a higher layer configuration by Downlink Control Information (DCI).

Applying a higher layer configuration regarding the (maximum) number of subcarriers to be deleted and their positions for both MTC Physical Downlink Control Channel (MPDCCH) and Physical Downlink Shared Channel (PDSCH).

Whether to delete Demodulation Reference Signal (DMRS), Channel State Information-Reference Signal (CSI-RS), and Space-frequency Block Code Resource Element (SFBC RE) pair.

As described above, it is assumed that the maximum number of LTE-MTC DL subcarriers that can be deleted is 2. An example of a case of deleting (puncturing) LTE-MTC DL subcarriers is described below.

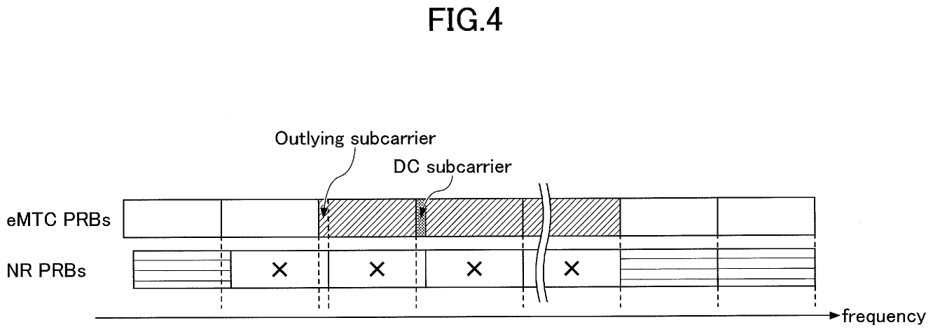

FIG. 4 is a diagram illustrating an example of an outlying subcarrier of eMTC. In the example of FIG. 4, eMTC carriers include a DC subcarrier. Accordingly, as illustrated in FIG. 4, an eMTC PRB grid including the DC subcarrier is shifted by one subcarrier toward the lower frequency side in the frequency direction with respect to a corresponding NR PRB grid. In addition, the eMTC PRB grid that is adjacent to the eMTC PRB including a DC subcarrier on the lower frequency side in the frequency direction (PRB grid at the lowest frequency position among the eMTC PRBs in FIG. 4) is also shifted by one subcarrier toward the lower frequency side in the frequency direction with respect to the corresponding NR PRB grid.

When the PRB grid at the lowest frequency position among the eMTC PRBs in FIG. 4 is shifted by one subcarrier toward the lower frequency side in the frequency direction with respect to the corresponding NR PRB grid, it is assumed that the base station 10 makes a reservation so as not to use the NR PRB at a position overlapping one subcarrier of the eMTC in the frequency direction. However, as illustrated in FIG. 4, it is considered that a portion not overlapping the outlying subcarrier of the eMTC in the frequency direction, among the NR PRBs that are reserved so as not to be used, can be used for communication. Accordingly, due to making a reservation so as not to use the NR PRB at the position overlapping the outlying subcarrier of the eMTC in the frequency direction, it is likely that the frequency utilization efficiency will be reduced. Here, the outlying subcarrier of the eMTC is a subcarrier located at the lower end or the upper end in the frequency direction of the transmission frequency band of the eMTC, which is offset with respect to the NR PRB grid due to the fact that the DC subcarrier is not used.

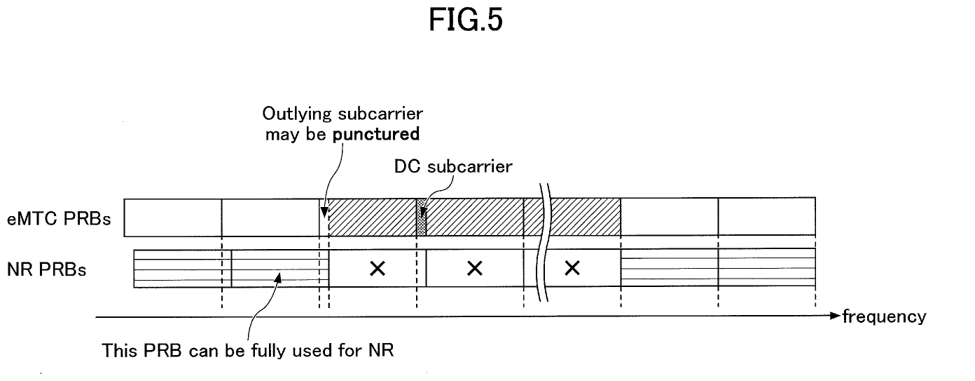

FIG. 5 is a diagram illustrating an example of puncturing the outlying subcarrier of the eMTC illustrated in FIG. 4. In the example of FIG. 5, the base station 10 punctures the outlying subcarrier of the eMTC illustrated in FIG. 4 when performing eMTC DL scheduling. Accordingly, in the example of FIG. 5, the NR PRB at the position overlapping the outlying subcarrier of the eMTC in the frequency direction in FIG. 4 does not overlap the eMTC carrier in the frequency direction. In the example of FIG. 5, because it is not necessary to make a reservation so as not to use the NR PRB at the position overlapping the outlying subcarrier of the eMTC in the frequency direction in the example of FIG. 4, the base station 10 and the terminal 20 can use the NR PRB for NR communication. Accordingly, it is possible to enhance the frequency utilization efficiency by puncturing the outlying subcarrier of the eMTC.

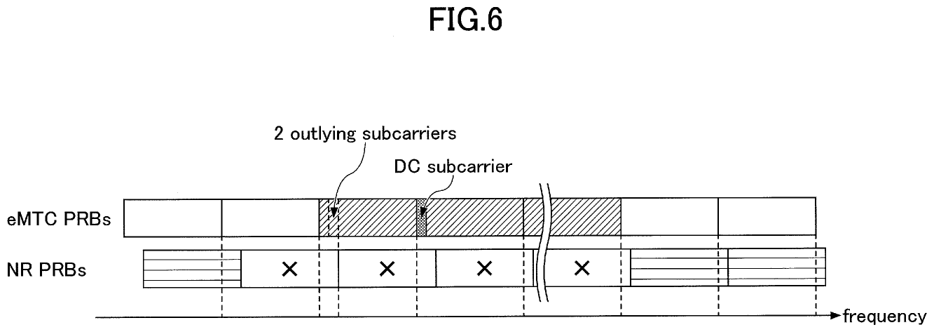

FIG. 6 is a diagram illustrating another example of outlying subcarriers of eMTC. In the example of FIG. 6, eMTC carriers include a DC subcarrier. Accordingly, as illustrated in FIG. 6, the eMTC PRB grid including the DC subcarrier is shifted by two subcarriers toward the lower frequency side in the frequency direction with respect to the corresponding NR PRB grid. In addition, the eMTC PRB grid that is adjacent to the eMTC PRB including a DC subcarrier on the lower frequency side in the frequency direction (PRB grid at the lowest frequency position among the eMTC PRBs in FIG. 6) is also shifted by two subcarriers toward the lower frequency side in the frequency direction with respect to the corresponding NR PRB grid.

When the PRB grid at the lowest frequency position among the eMTC PRBs in FIG. 6 is shifted by two subcarriers toward the lower frequency side in the frequency direction with respect to the corresponding NR PRB grid, it is assumed that the base station 10 makes a reservation so as not to use the NR PRB at a position overlapping the two subcarriers of the eMTC in the frequency direction. However, as illustrated in FIG. 6, it is considered that a portion not overlapping the two outlying subcarriers of the eMTC in the frequency direction, among the NR PRBs that are reserved so as not to be used, can be used for communication. Accordingly, due to making a reservation so as not to use the NR PRB at the position overlapping the two outlying subcarriers of the eMTC in the frequency direction, it is likely that the frequency utilization efficiency will be reduced.

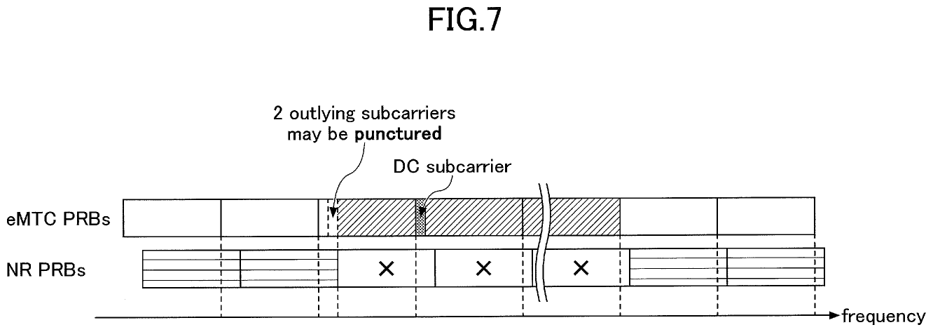

FIG. 7 is a diagram illustrating an example of puncturing two outlying subcarriers of the eMTC illustrated in FIG. 6. In the example of FIG. 7, the base station 10 punctures two outlying subcarriers of the eMTC illustrated in FIG. 6 when performing eMTC DL scheduling. Accordingly, in the example of FIG. 7, the NR PRB at the position overlapping the two outlying subcarriers of the eMTC in the frequency direction in FIG. 6 does not overlap the eMTC carrier in the frequency direction. In the example of FIG. 7, because it is not necessary to make a reservation so as not to use the NR PRB at the position overlapping the two outlying subcarriers of the eMTC in the frequency direction in the example of FIG. 6, the base station 10 and the terminal 20 can use the NR PRB for NR communication. Accordingly, it is possible to enhance the frequency utilization efficiency by puncturing the two outlying subcarriers of the eMTC.

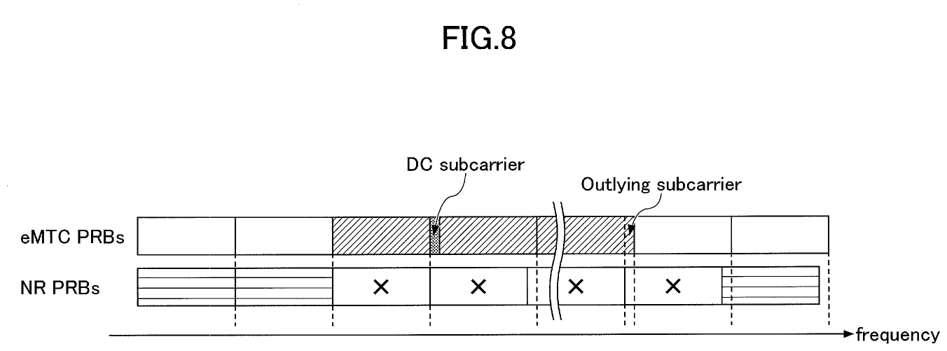

FIG. 8 is a diagram illustrating another example of an outlying subcarrier of eMTC. In the example illustrated in FIG. 8, eMTC carriers include a DC subcarrier. Accordingly, as illustrated in FIG. 8, the eMTC PRB grid including the DC subcarrier is shifted by one subcarrier toward the higher frequency side in the frequency direction with respect to the corresponding NR PRB grid. In addition, the PRB grid at the highest frequency position among the eMTC PRBs in FIG. 8 is also shifted by one subcarrier toward the higher frequency side in the frequency direction with respect to the corresponding NR PRB grid.

When the PRB grid at the highest frequency position among the eMTC PRBs in FIG. 8 is shifted by one subcarrier toward the higher frequency side in the frequency direction with respect to the corresponding NR PRB grid, it is assumed that the base station 10 makes a reservation so as not to use the NR PRB at a position overlapping the one subcarrier of the eMTC in the frequency direction. However, as illustrated in FIG. 8, it is considered that a portion not overlapping the outlying subcarrier of the eMTC in the frequency direction, among the NR PRBs that are reserved so as not to be used, can be used for communication. Accordingly, due to making a reservation so as not to use the NR PRB at the position overlapping the outlying subcarrier of the eMTC in the frequency direction, it is likely that the frequency utilization efficiency will be reduced.

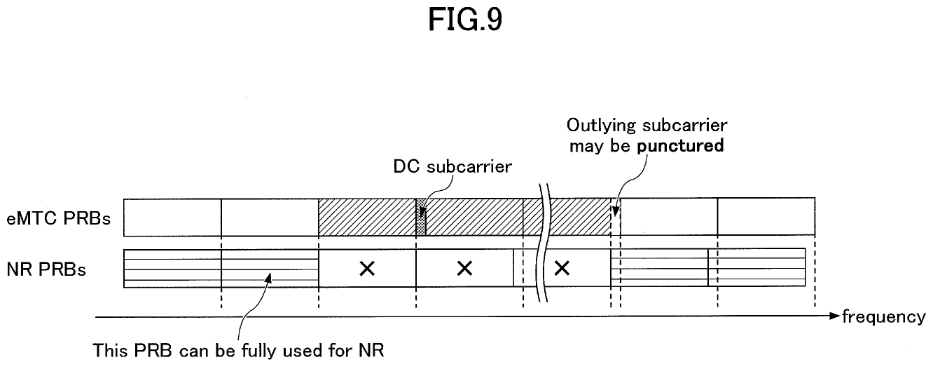

FIG. 9 is a diagram illustrating an example of puncturing the outlying subcarrier of the eMTC illustrated in FIG. 8. In the example of FIG. 9, the base station 10 punctures the outlying subcarrier of the eMTC illustrated in FIG. 8 when performing eMTC DL scheduling. Accordingly, in the example of FIG. 9, the NR PRB at the position overlapping the outlying subcarrier of the eMTC in the frequency direction in FIG. 8 does not overlap the eMTC carrier in the frequency direction. In the example of FIG. 9, because it is not necessary to make a reservation so as not to use the NR PRB at the position overlapping the outlying subcarrier of the eMTC in the frequency direction in the example of FIG. 8, the base station 10 and the terminal 20 can use the NR PRB for NR communication. Accordingly, it is possible to enhance the frequency utilization efficiency by puncturing the outlying subcarrier of the eMTC.

Note that, in the example described above, the maximum number of outlying subcarriers of eMTC to be punctured is set to 2, but the embodiments are not limited to this example. For example, the maximum number of outlying subcarriers of eMTC to be punctured may be 3 or more. As described above, as patterns for puncturing the outlying subcarriers of the eMTC, at least four patterns of (1) a pattern for puncturing one outlying subcarrier on the low frequency side, (2) a pattern for puncturing two outlying subcarriers on the low frequency side, (3) a pattern for puncturing one outlying subcarrier on the high frequency side, and (4) a pattern for puncturing two outlying subcarriers on the high frequency side can be considered.

Accordingly, the base station 10 may transmit, to the terminal 20, a notification that the outlying subcarrier on the high frequency side is to be punctured, or may transmit, the terminal 20, a notification that the outlying subcarrier on the low frequency side is to be punctured. In addition, the base station 10 may transmit, the terminal 20, a notification of the number of outlying subcarriers to be punctured.

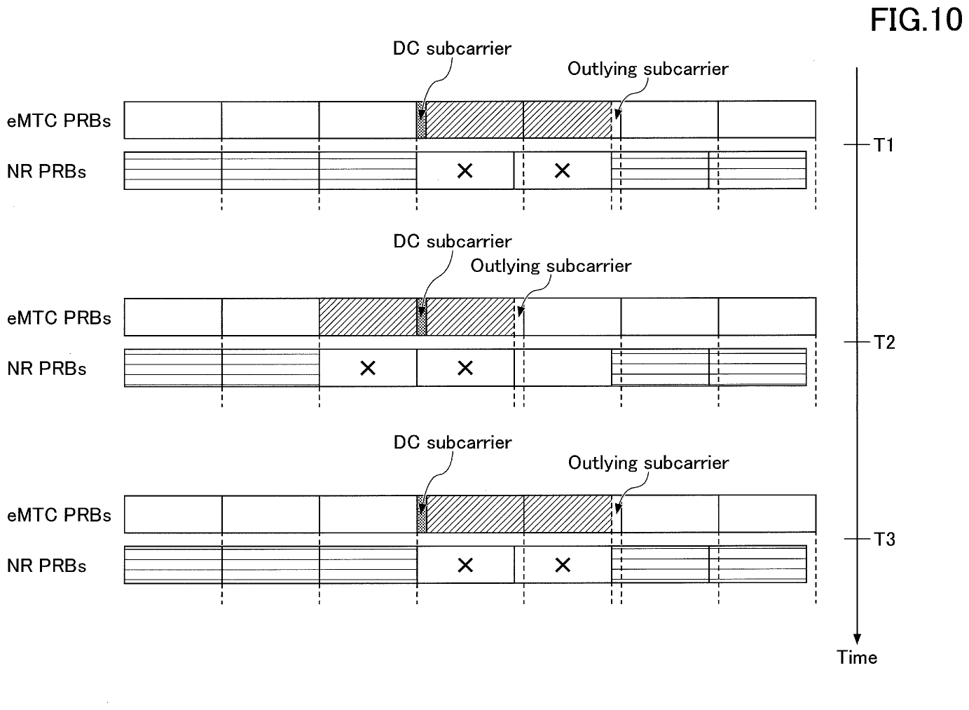

FIG. 10 is a diagram illustrating another example of puncturing the outlying subcarriers of eMTC. As in the example described above, when the base station 10 reserves the NR PRB semi-statically for eMTC communication, the base station 10 may puncture one or two outlying subcarriers, which are arranged at the end on the low frequency side or the end on the high frequency side in the frequency direction in the entire eMTC bandwidth, when performing eMTC DL scheduling. However, when the base station 10 dynamically schedules the NR PRB, the position of the outlying subcarrier in the frequency direction may also be dynamically changed. In the example of FIG. 10, the base station 10 dynamically schedules the NR PRB. When performing DL scheduling, the base station 10 may schedule two PRBs for eMTC communication, make a reservation so as not to use NR PRBs corresponding to the two PRBs for eMTC communication, and schedule the remaining RPBs for NR communication.

For example, at time T1 in the example of FIG. 10, the base station 10 punctures one outlying subcarrier, which is arranged at the end on the high frequency side of the entire bandwidth for eMTC communication, when performing DL scheduling. Subsequently, at time T2 in the example of FIG. 10, the base station 10 applies another mapping of the NR PRB, and the position of the PRB for eMTC communication is also changed accordingly. In this case, the base station 10 punctures one outlying subcarrier arranged at the end on the high frequency side in the entire bandwidth for eMTC communication after the change. Subsequently, at time T3 in the example of FIG. 10, the base station 10 applies another mapping of the NR PRB, and the position of the PRB for eMTC communication is also changed accordingly. In this case, the base station 10 punctures one outlying subcarrier arranged at the end on the high frequency side in the frequency direction in the entire bandwidth for eMTC communication after the change. As described above, when the base station 10 dynamically schedules the NR PRB, the position of the outlying subcarrier to be punctured may be dynamically changed.

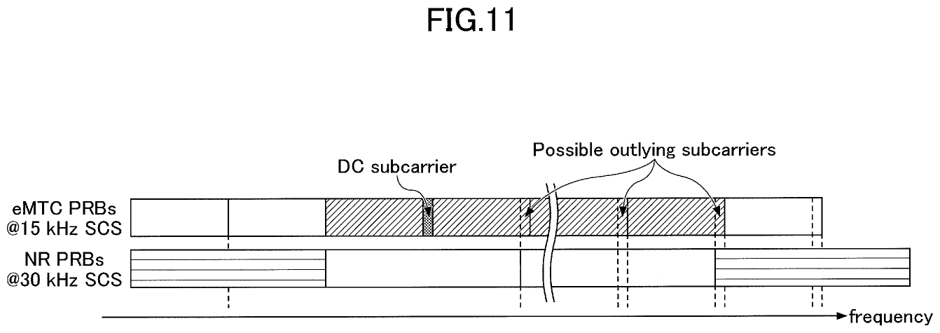

FIG. 11 is a diagram illustrating another example of the outlying subcarrier of eMTC. In the example of FIG. 11, 15 kHz is applied as a subcarrier spacing (SCS) of eMTC. in contrast, 30 kHz is applied as a subcarrier spacing of NR. As described above, even when the LTE numerology and the NR numerology are different from each other, the above-described problem of frequency utilization efficiency reduction due to outlying subcarriers may occur.

In the case of puncturing outlying subcarriers, the base station 10 may transmit, the eMTC terminal 20, a notification of information regarding the outlying subcarriers to be punctured by higher layer signaling. It is necessary to clarify the content of the notification transmitted by higher layer signaling.

When eMTC and NR coexist, the base station 10 may transmit, to the terminal 20, a notification of at least the number of outlying subcarriers and the positions (on the low frequency side or on the high frequency side) of the outlying subcarriers in the frequency domain by signaling regarding the puncturing of DL subcarriers of eMTC.

Additionally, by signaling regarding the puncturing of DL subcarriers of eMTC, the base station 10 may transmit, the terminal 20, a notification that (Alt. 1) the DL transmission frequency band of the eMTC is semi-statically allocated and the NR frequency resource corresponding to the DL transmission frequency band of the eMTC is semi-statically reserved or (Alt. 2) the DL transmission frequency band of the eMTC is dynamically allocated and the NR frequency resource corresponding to the DL transmission frequency band of the eMTC is dynamically reserved.

In the case of Alt. 1 described above, the outlying subcarrier on the low frequency side or the high frequency side of the DL transmission frequency band of the eMTC that is semi-statically allocated may be punctured. In addition, in the case of Alt. 2 described above, the outlying subcarrier on the low frequency side or the high frequency side of the DL transmission frequency band of the eMTC that is dynamically allocated may be punctured.

Additionally, by signaling regarding the puncturing of DL subcarriers of eMTC, for each narrow band (NB: Narrow Band) (or for each frequency position), the base station 10 may transmit, to the terminal 20, a notification that (Alt. 1) the DL transmission frequency band of the eMTC is semi-statically allocated and the NR frequency resource corresponding to the DL transmission frequency band of the eMTC is semi-statically reserved or (Alt. 2) the DL transmission frequency band of the eMTC is dynamically allocated and the NR frequency resource corresponding to the DL transmission frequency band of the eMTC is dynamically reserved.

Additionally, for each NR numerology, that is, for each subcarrier spacing, and for each narrow band (NB: Narrow Band) (or for each frequency position), the base station 10 may transmit, to the terminal 20, a notification that (Alt. 1) the DL transmission frequency band of the eMTC is semi-statically allocated and the NR frequency resource corresponding to the DL transmission frequency band of the eMTC is semi-statically reserved or (Alt. 2) the DL transmission frequency band of the eMTC is dynamically allocated and the NR frequency resource corresponding to the DL transmission frequency band of the eMTC is dynamically reserved.

Additionally, the signaling regarding the puncturing of DL subcarriers of the eMTC described above may be performed by any of a System Information Block (SIB), terminal-specific higher layer signaling (UE-specific higher layer signaling), or L1 signaling (physical layer signaling) or a combination thereof. In addition, the signaling regarding the puncturing of DL subcarriers of the eMTC described above may be performed based on optional signaling to the terminal 20 supporting Release 16 and/or the terminal 20 supporting a release later than Release 16.

(Device Configuration)

Next, examples of functional configurations of the base station 10 and the terminal 20 are described that perform the processing operation described above. The base station 10 and the terminal 20 include all the functions described in the embodiments. However, the base station 10 and the terminal 20 may include only a part of the functions described in the embodiments.

<The Base Station 10>

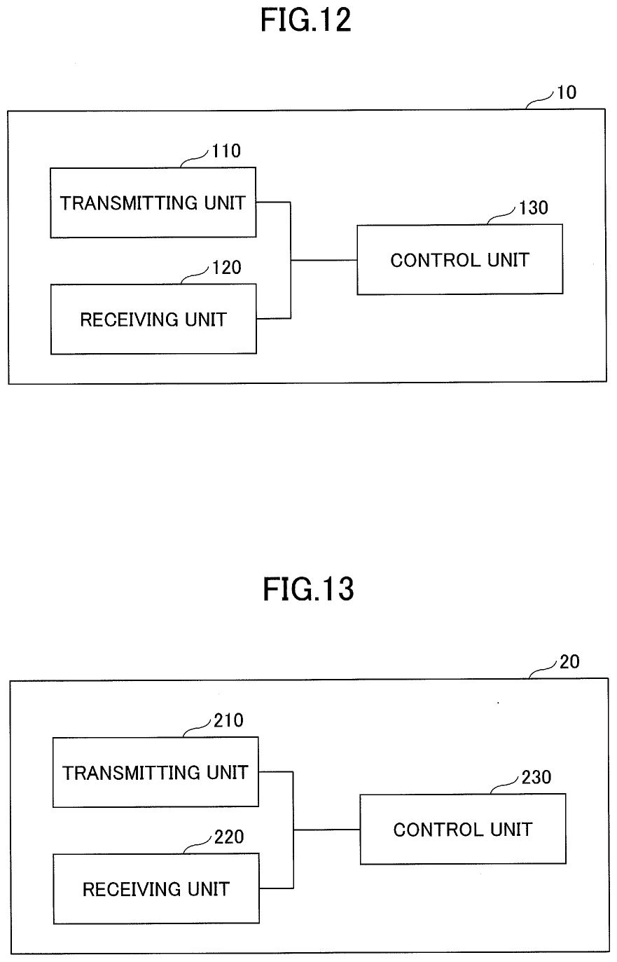

FIG. 12 is a diagram illustrating an example of a functional configuration of the base station 10. As illustrated in FIG. 12, the base station 10 includes a transmitting unit 110, a receiving unit 120, and a control unit 130. The functional configuration illustrated in FIG. 12 is only one example. If the operation according to the embodiments can be executed, functional divisions and names of the functional units may be any divisions and names.

The transmitting unit 110 creates a transmission signal from transmission data and wirelessly transmits the transmission signal. The receiving unit 120 receives various signals wirelessly and obtains higher layer signals from the received physical layer signals. The receiving unit 120 includes a measuring unit that measures a received signal and obtains a received power.

The control unit 130 controls the base station 10. The function of the control unit 130 related to transmission may be included in the transmitting unit 110, and the function of the control unit 130 related to reception may be included in the receiving unit 120.

For example, when performing NR DL scheduling and eMTC DL scheduling, the control unit 130 of the base station 10 may make a reservation so as not to use the NR PRB arranged at a position in the frequency direction that overlaps the position of the eMTC PRB in the frequency direction.

In addition, for example, when performing NR DL scheduling and eMTC DL scheduling, the control unit 130 of the base station 10 may puncture the outlying subcarrier of the eMTC and may schedule the NR PRB arranged at a position in the frequency direction, which overlaps the position of the outlying subcarrier of the eMTC in the frequency direction, for NR communication before puncturing the outlying subcarrier of the eMTC.

In addition, for example, when puncturing the outlying subcarrier of the eMTC, the control unit 130 of the base station 10 may configure, as information regarding the puncturing of the outlying subcarrier, at least the number of outlying subcarriers and the positions (on the low frequency side or on the high frequency side) of the outlying subcarriers in the frequency domain, and the transmitting unit 110 may transmit the configured information to the terminal 20.

In addition, for example, as information regarding the puncturing of the outlying subcarrier, in addition to the number of outlying subcarriers and the positions of the outlying subcarriers in the frequency domain, the control unit 130 of the base station 10 may configure the information that (Alt. 1) the DL transmission frequency band of the eMTC is semi-statically allocated and the NR frequency resource corresponding to the DL transmission frequency band of the eMTC is semi-statically reserved or (Alt. 2) the DL transmission frequency band of the eMTC is dynamically allocated and the NR frequency resource corresponding to the DL transmission frequency band of the eMTC is dynamically reserved, and transmitting unit 110 may transmit the configured information to the terminal 20.

In addition, for example, in the case of Alt. 1, the control unit 130 of the base station 10 may puncture the outlying subcarrier on the low frequency side or the high frequency side of the DL transmission frequency band of the eMTC that is semi-statically allocated. In addition, in the case of Alt. 2 described above, the control unit 130 of the base station 10 may puncture the outlying subcarrier on the low frequency side or the high frequency side of the DL transmission frequency band of the eMTC that is dynamically allocated.

In addition, for example, as information regarding the puncturing of the outlying subcarrier, for each narrow band (NB) (or for each frequency position), the control unit 130 of the base station 10 may configure the number of outlying subcarriers, the positions of the outlying subcarriers in the frequency domain, and the information that (Alt. 1) the DL transmission frequency band of the eMTC is semi-statically allocated and the NR frequency resource corresponding to the DL transmission frequency band of the eMTC is semi-statically reserved or (Alt. 2) the DL transmission frequency band of the eMTC is dynamically allocated and the NR frequency resource corresponding to the DL transmission frequency band of the eMTC is dynamically reserved, and transmitting unit 110 may transmit the configured information to the terminal 20.

In addition, for example, as information regarding the puncturing of the outlying subcarrier, for each NR numerology, that is, for each subcarrier spacing, and for each narrow band (NB: Narrow Band) (or for each frequency position), the control unit 130 of the base station 10 may configure the information that (Alt. 1) the DL transmission frequency band of the eMTC is semi-statically allocated and the NR frequency resource corresponding to the DL transmission frequency band of the eMTC is semi-statically reserved or (Alt. 2) the DL transmission frequency band of the eMTC is dynamically allocated and the NR frequency resource corresponding to the DL transmission frequency band of the eMTC is dynamically reserved, and transmitting unit 110 may transmit the configured information to the terminal 20.

<Terminal 20>

FIG. 13 is a diagram illustrating an example of a functional configuration of the terminal 20. As illustrated in FIG. 13, the terminal 20 includes a transmitting unit 210, a receiving unit 220, and a control unit 230. The functional configuration illustrated in FIG. 13 is only one example. The functional division and the names of the functional units may be any division and names, provided that the operation according to the present invention can be executed.

The transmitting unit 210 includes a function for generating a signal to be transmitted to the base station 10 and transmitting the signal wirelessly. The receiving unit 220 includes a function for receiving various signals transmitted from the base station 10 and acquiring, for example, information of a higher layer from the received signals. The receiving unit 220 includes a measuring unit for measuring a signal to be received and for obtaining received power.

The control unit 230 controls the terminal 20. A function of the control unit 230 related to transmission may be included in the transmitting unit 210, and a function of the control unit 230 related to reception may be included in the receiving unit 220.

For example, the receiving unit 220 of the terminal 20 may receive signaling regarding the puncturing of DL subcarriers of eMTC transmitted from the base station 10, the control unit 230 may configure the number of outlying subcarriers to be punctured and the positions (on the low frequency side or on the high frequency side) of the outlying subcarriers to be punctured in the frequency domain based on the information received by the receiving unit 220, and the receiving unit 220 may receive the DL carrier of the eMTC other than the outlying subcarriers to be punctured.

In addition, for example, the receiving unit 220 of the terminal 20 may receive signaling regarding the puncturing of DL subcarriers of eMTC, the control unit 230 may configure a semi-static reception frequency band in which the outlying subcarrier is punctured, as the DL reception frequency band of the eMTC, in response to detecting that the information received by the receiving unit 220 includes information indicating that (Alt. 1) the DL transmission frequency band of the eMTC is semi-statically allocated, and the receiving unit 220 may receive the DL carrier of the eMTC other than the outlying subcarriers to be punctured.

In addition, for example, the receiving unit 220 of the terminal 20 may receive signaling regarding the puncturing of DL subcarriers of eMTC, the control unit 230 may dynamically configure a reception frequency band in which the outlying subcarrier is punctured, as the DL reception frequency band of the eMTC, in response to detecting that the information received by the receiving unit 220 includes information indicating that (Alt. 2) the DL transmission frequency band of the eMTC is dynamically allocated, and the receiving unit 220 may receive the DL carrier of the eMTC other than the outlying subcarriers to be punctured.

In addition, for example, the receiving unit 220 of the terminal 20 may receive signaling regarding the puncturing of DL subcarriers of eMTC. Upon detecting that information indicating that (Alt. 1) the DL transmission frequency band of the eMTC is semi-statically allocated is included in the information received by the receiving unit 220 as configuration information for each narrow band, the control unit 230 may configure, as the DL reception frequency band of the eMTC in the narrow band, a semi-static reception frequency band in which the outlying subcarrier has been punctured. Upon detected that information indicating that (Alt. 2) the DL transmission frequency band of the eMTC is dynamically allocated is included in the information received by the receiving unit 220 as configuration information for each narrow band, the control unit 230 may dynamically configure, as the DL reception frequency band of the eMTC in the narrow band, a reception frequency band in which the outlying subcarrier has been punctured. The receiving unit 220 may receive the DL carrier of the eMTC other than the outlying subcarriers to be punctured.

In addition, for example, the receiving unit 220 of the terminal 20 may receive signaling regarding the puncturing of DL subcarriers of eMTC. Upon detecting that numerology applied to NR, that is, information indicating the subcarrier spacing is included in the information received by the receiving unit 220 and information indicating that (Alt. 1) the DL transmission frequency band of the eMTC is semi-statically allocated is included in the information received by the receiving unit 220 as configuration information for each subcarrier spacing and each narrow band, the control unit 230 may configure, as the DL reception frequency band of the eMTC in the narrow band, a semi-static reception frequency band which corresponds to the subcarrier spacing applied to NR and in which the outlying subcarrier is punctured. Upon detecting that information indicating that (Alt. 2) the DL transmission frequency band of the eMTC is dynamically allocated is included in the information received by the receiving unit 220 as configuration information for each subcarrier spacing and each narrow band, the control unit 230 may dynamically configure, as the DL reception frequency band of the eMTC in the narrow band, a reception frequency band which corresponds to the subcarrier spacing applied to NR and in which the outlying subcarrier is punctured. The receiving unit 220 may receive the DL carrier of the eMTC other than the outlying subcarriers to be punctured.

In addition, for example, the receiving unit 220 of the terminal 20 may receive signaling regarding the puncturing of DL subcarriers of eMTC by any of System Information Block (SIB), terminal-specific higher layer signaling (UE-specific higher layer signaling), or L1 signaling (physical layer signaling) or a combination thereof.

<Hardware Configuration>

The block diagrams (FIG. 12 to FIG. 13) used for the description of the above embodiments show blocks of functional units. These functional blocks (components) are implemented by any combination of at least one of hardware and software. In addition, the implementation method of each functional block is not particularly limited. That is, each functional block may be implemented using a single device that is physically or logically combined, or may be implemented by directly or indirectly connecting two or more devices that are physically or logically separated (e.g., using wire, radio) and using these multiple devices. The functional block may be implemented by combining software with the above-described one device or the above-described plurality of devices. Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, and the like. For example, a functional block (component) that functions to transmit is called a transmitting unit or a transmitter. In either case, as described above, the implementation method is not particularly limited.

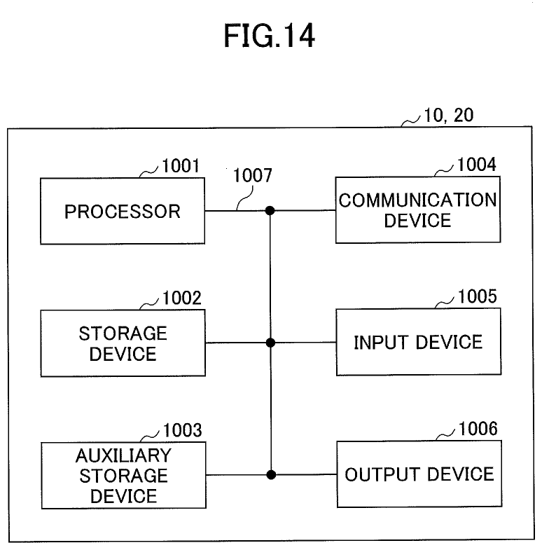

For example, each of the base station 10 and the terminal 20 according to an embodiment of the present invention may function as a computer performing the process according to the embodiments. FIG. 14 is a diagram illustrating an example of a hardware configuration of the base station 10 and the terminal 20 according to the embodiment. Each of the above-described base station 10 and terminal 20 may be physically configured as a computer device including a processor 1001, a storage device 1002, an auxiliary storage device 1003, a communication device 1004, an input device 1005, an output device 1006, a bus 1007, and the like.

In the following description, the term “device” can be replaced with a circuit, a device, a unit, or the like. The hardware configuration of the base station 10 and terminal 20 may include one or more of the devices denoted by 1001-1006 in the figure, or may be configured without some devices.

Each function of the base station 10 and terminal 20 is implemented by loading predetermined software (program) on hardware, such as the processor 1001 and the storage device 1002, so that the processor 1001 performs computation and controls communication by the communication device 1004, and at least one of reading and writing of data in the storage device 1002 and the auxiliary storage device 1003.

The processor 1001, for example, operates an operating system to control the entire computer. The processor 1001 may be configured with a central processing unit (CPU: Central Processing Unit) including an interface with a peripheral device, a control device, a processing device, a register, and the like.

Additionally, the processor 1001 reads a program (program code), a software module, data, and the like, from at least one of the auxiliary storage device 1003 and the communication device 1004 to the storage device 1002, and executes various processes according to these. As the program, a program is used that causes a computer to execute at least a part of the operations described in the above-described embodiments. For example, the control unit 130 of the base station 10 may be implemented by a control program that is stored in the storage device 1002 and that is operated by the processor 1001, and other functional blocks may be similarly implemented. While the various processes described above are described as being executed in one processor 1001, they may be executed simultaneously or sequentially by two or more processors 1001. The processor 1001 may be implemented by one or more chips. The program may be transmitted from a network via a telecommunications line.

The storage device 1002 is a computer readable storage medium, and, for example, the storage device 1002 may be formed of at least one of a Read Only Memory (ROM), an Erasable Programmable ROM (EPROM), an Electrically Erasable Programmable ROM (EEPROM), a Random Access Memory (RAM), and the like. The storage device 1002 may be referred to as a register, a cache, a main memory (main storage device), or the like. The storage device 1002 may store a program (program code), a software module, or the like, which can be executed for implementing the radio communication method according to one embodiment of the present disclosure.

The auxiliary storage device 1003 is a computer readable storage medium and may be formed of, for example, at least one of an optical disk, such as a CD-ROM (Compact Disc ROM), a hard disk drive, a flexible disk, an optical magnetic disk (e.g., a compact disk, a digital versatile disk, a Blu-ray (registered trademark) disk, a smart card, a flash memory (e.g., a card, a stick, a key drive), a floppy (registered trademark) disk, a magnetic strip, and the like. The auxiliary storage device 1003 may be referred to as an auxiliary storage device. The above-described storage medium may be, for example, a database including at least one of the storage device 1002 and the auxiliary storage device 1003, a server, or any other suitable medium.

The communication device 1004 is hardware (transmitting and receiving device) for performing communication between computers through at least one of a wired network and a wireless network, and is also referred to, for example, as a network device, a network controller, a network card, a communication module, or the like. The communication device 1004 may be configured to include, for example, a high frequency switch, a duplexer, a filter, a frequency synthesizer, or the like, to implement at least one of frequency division duplex (FDD: Frequency Division Duplex) and time division duplex (TDD: Time Division Duplex).

The input device 1005 is an input device (e.g., a keyboard, a mouse, a microphone, a switch, a button, and/or a sensor) that receives an external input. The output device 1006 is an output device (e.g., a display, a speaker, and/or an LED lamp) that performs output toward outside. The input device 1005 and the output device 1006 may be configured to be integrated (e.g., a touch panel).

Each device, such as the processor 1001 and the storage device 1002, is also connected by the bus 1007 for communicating information. The bus 1007 may be formed of a single bus or may be formed of different buses between devices.

The base station 10 and the terminal 20 may each include hardware, such as a microprocessor, a digital signal processor (DSP: Digital Signal Processor), an Application Specific Integrated Circuit (ASIC), a Programmable Logic Device (PLD), and a Field Programmable Gate Array (FPGA), which may implement some or all of each functional block. For example, processor 1001 may be implemented using at least one of these hardware components.

### Conclusion of the Embodiments

In this specification, at least the user equipment and the communication method below are disclosed.

A terminal including a receiving unit that receives configuration information regarding puncturing of a downlink subcarrier of a first Radio Access Technology (RAT) among a plurality of supported RATs; and a control unit that configures a number of one or more outlying subcarriers of the first RAT and a position of the one or more outlying subcarriers of the first RAT in a frequency domain based on the configuration information and configures a reception frequency band of a downlink carrier of the first RAT by puncturing a frequency band of the one or more outlying subcarriers.

According to the configuration described above, in the case where the outlying subcarriers are to be punctured and the information regarding the outlying subcarriers to be punctured is to be transmitted by higher layer signaling, the content of the notification to be transmitted by the higher layer signaling is clarified. Note that, for example, the plurality of RATs may include at least Machine Type Communication and NR, and the first RAT may be Machine Type Communication.

In a case where the configuration information includes information indicating that a downlink transmission band of the first RAT is semi-statically allocated, the control unit may configure, as the reception frequency band of the downlink carrier of the first RAT, a semi-static reception frequency band obtained by puncturing the frequency band of the one or more outlying subcarriers, and in a case where the configuration information includes information indicating that the downlink transmission frequency band of the first RAT is dynamically allocated, the control unit may dynamically configure, as the reception frequency band of the downlink carrier of the first RAT, a reception frequency band obtained by puncturing the frequency band of the one or more outlying subcarriers.

According to the configuration described above, even if the frequency position of the outlying subcarrier changes with time, the terminal can dynamically configure the reception frequency band, in which the frequency band of the outlying subcarrier is deleted, based on the information indicating that the downlink transmission band is dynamically allocated.

The receiving unit may receive, as the configuration information, configuration information of each narrow band of a plurality of narrow bands included in a frequency band of the downlink carrier of the first RAT, wherein, for each narrow band of the plurality of narrow bands, when the configuration information of the narrow band includes information indicating that the downlink transmission frequency band of the first RAT is semi-statically allocated, the control unit may configure, as the reception frequency band of the downlink carrier of the first RAT in the narrow band, a semi-static reception frequency band obtained by puncturing the frequency band of the one or more outlying subcarriers, and wherein, when the configuration information of the narrow band includes information indicating that the downlink transmission frequency band of the first RAT is dynamically allocated, the control unit may dynamically configure, as the reception frequency band of the downlink carrier of the first RAT in the narrow band, a reception frequency band obtained by puncturing the frequency band of the one or more outlying subcarriers.

According to the configuration described above, it is possible to configure, on a per narrow band basis, the reception frequency band, in which the frequency band of the outlying subcarrier is deleted.

The configuration information may include information indicating a subcarrier spacing applied to a second RAT among the plurality of RATs, wherein, for each narrow band of the plurality of narrow bands, when the configuration information of the narrow band includes information indicating that the downlink transmission frequency band of the first RAT is semi-statically allocated, the control unit may configure, as the reception frequency band of the downlink carrier of the first RAT in the narrow band, a semi-static reception frequency band corresponding to the subcarrier spacing and obtained by puncturing the frequency band of the one or more outlying subcarriers, and wherein, when the configuration information of the narrow band includes information indicating that the downlink transmission frequency band of the first RAT is dynamically allocated, the control unit may dynamically configures, as the reception frequency band of the downlink carrier of the first RAT in the narrow band, a reception frequency band corresponding to the subcarrier spacing and obtained by puncturing the frequency band of the one or more outlying subcarriers.

According to the configuration described above, the reception frequency band corresponding to the subcarrier spacing applied to the second RAT among the plurality of RATs and obtained by puncturing the frequency band of the outlying subcarriers can be configured on a per narrow band basis. Note that, for example, the second RAT among the plurality of RATs may be New Radio (NR).

A communication method executed by a terminal, the method including receiving configuration information regarding puncturing of a downlink subcarrier of a first RAT among a plurality of supported Radio Access Technologies (RATs); and configuring a number of one or more outlying subcarriers of the first RAT and positions of the one or more outlying subcarriers of the first RAT in a frequency domain based on the configuration information and configuring a reception frequency band of a downlink carrier of the first RAT by puncturing a frequency band of the one or more outlying subcarriers.

According to the configuration described above, in the case where the outlying subcarriers are to be punctured and the information regarding the outlying subcarriers to be punctured is to be transmitted by higher layer signaling, the content of the notification to be transmitted by the higher layer signaling is clarified.

### Supplemental Embodiment

The embodiments of the present invention are described above, but the disclosed invention is not limited to the above-described embodiments, and those skilled in the art would understand various modified examples, revised examples, alternative examples, substitution examples, and the like. In order to facilitate understanding of the present invention, specific numerical value examples are used for description, but the numerical values are merely examples, and certain suitable values may be used unless otherwise stated. The classification of items in the above description is not essential to the present invention. Matters described in two or more items may be combined and used if necessary, and a matter described in one item may be applied to a matter described in another item (unless inconsistent). The boundary between functional units or processing units in a functional block diagram does not necessarily correspond to the boundary between physical parts. Operations of a plurality of functional units may be performed physically by one component, or an operation of one functional unit may be physically performed by a plurality of parts. In the processing procedure described in the embodiments, the order of the processes may be changed as long as there is no contradiction. For the sake of convenience of processing description, the base station 10 and the terminal 20 are described using the functional block diagrams, but such devices may be implemented by hardware, software, or a combination thereof. Software executed by the processor included in the base station 10 according to the embodiments of the present invention and software executed by the processor included in the terminal 20 according to the embodiments of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

Furthermore, a notification of information is not limited to the aspects or embodiments described in the present disclosure and may be provided by any other method. For example, the notification of information may be provided by physical layer signaling (for example, downlink control information (DCI) or uplink control information (UCI)), upper layer signaling (for example, radio resource control (RRC) signaling, medium access control (MAC) signaling, broadcast information (master information block (MIB), system information block (SIB)), other signals, or a combination thereof. Furthermore, the RRC signaling may be referred to as an RRC message and may be, for example, an RRC connection setup message, an RRC connection reconfiguration message, or the like.

Each aspect and embodiment described in the present disclosure may be applied to at least one of Long Term Evolution (LTE), LTE-advanced (LTE-A), SUPER 3G, IMT-advanced, 4th generation mobile communication system (4G), 5th generation mobile communication system (5G), Future Radio Access (FRA), new Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX(registered trademark)), IEEE 802.20, Ultra-WideBand (UWB), Bluetooth (registered trademark), a system using any other appropriate system, and next generation systems extended based on these standards. Furthermore, a plurality of systems (e.g., a combination of at least one of LTE and LTE-A with 5G) may be combined to be applied.

The processing procedures, the sequences, the flowcharts, and the like of the respective aspects/embodiments described in the present disclosure may be reversed in order provided that there is no contradiction. For example, the method described in the present disclosure presents elements of various steps with an exemplary order and is not limited to a presented specific order.

In the present disclosure, a specific operation to be performed by the base station 10 may be performed by an upper node in some cases. In the network including one or more network nodes including the base station 10, various operations performed for communication with the terminal can be obviously performed by at least one of the base station 10 and any network node (for example, an MME, an S-GW, or the like is considered, but it is not limited thereto) other than the base station 10. A case is exemplified above in which there is one network node other than the base station 10. The one network node may be a combination of a plurality of other network nodes (e.g., MME and S-GW).

Input and output information and the like may be stored in a specific place (for example, a memory) or may be managed through a management table. Input and output information and the like may be overwritten, updated, or additionally written. Output information and the like may be deleted. Input information and the like may be transmitted to another device.

The determination may be made in accordance with a value (0 or 1) indicated by one bit, may be performed in accordance with a Boolean value (true or false), or may be performed by a comparison of numerical values (for example, a comparison with a predetermined value).

The aspects/embodiments described in this disclosure may be used alone, in combination, or switched with implementation. Notification of predetermined information (e.g., “X” notice) is not limited to a method that is explicitly performed, and may also be made implicitly (e.g., “no notice of the predetermined information”).

Software can be interpreted widely to mean a command, a command set, a code, a code segment, a program code, a program, a subprogram, a software module, an application, a software application, a software package, a routine, a subroutine, an object, an executable file, an execution thread, a procedure, a function, and the like regardless of whether software is called software, firmware, middleware, a microcode, a hardware description language, or any other name.

Further, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL: Digital Subscriber Line)) and a radio technology (such as infrared rays or a microwave), at least one of the wired technology and the radio technology are included in a definition of a transmission medium.

Information, signals, and the like described in this disclosure may be indicated using any one of a variety of different techniques. For example, data, instructions, commands, information, signals, bits, symbols, chips, and the like which are mentioned throughout the above description may be indicated by voltages, currents, electromagnetic waves, magnetic particles, optical fields or photons, or any combination thereof.

The terms described in the present disclosure and terms necessary for understanding the present disclosure may be replaced with terms having the same or similar meanings. For example, at least one of a channel and a symbol may be a signal. Further, a signal may be a message. Further, a component carrier (CC: Component Carrier) may be referred to as a “carrier frequency,” a “cell,” or the like.

The terms “system” and “network” used in the present disclosure are used interchangeably. Further, information, parameters, and the like described in the present disclosure may be indicated by absolute values, may be indicated by relative values from predetermined values, or may be indicated by corresponding other information. For example, radio resources may be those indicated by an index.

The names used for the above-described parameters are not limited in any respect. Further, mathematical formulas or the like using the parameters may be different from those explicitly disclosed in the present disclosure. Since various channels (for example, a PUCCH, a PDCCH, and the like) and information elements can be identified by suitable names, various names assigned to the various channels and the information elements are not limited in any respect.

In the present disclosure, the terms “Base Station (BS),” “radio base station,” “fixed station,” “Node B,” “eNode B (eNB),” “gNodeB (gNB),” “access point,” “transmission point,” “reception point,” “transmission/reception point,” “cell,” “sector,” “cell group,” “carrier,” “component carrier,” and the like can be used interchangeably. The base stations may also be indicated by terms such as a macrocell, a small cell, a femtocell, and a picocell.

The base station eNB can accommodate one or more (for example, three) cells. In a case in which the base station accommodates a plurality of cells, the entire coverage area of the base station can be partitioned into a plurality of small areas, and each small area can provide a communication service through a base station subsystem (for example, a small indoor base station (a remote radio head (RRH)). The term “cell” or “sector” refers to the whole or a part of the coverage area of at least one of the base station and the base station subsystem that performs a communication service in the coverage.

In the present disclosure, the terms “Mobile Station (MS),” “user terminal,” “User Equipment (UE),” “terminal,” and the like can be used interchangeably.

The mobile station may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

At least one of the base station and the mobile station may be also referred to as a transmitting device, a receiving device, a communication device, or the like. At least one of the base station and the mobile station may be a device installed in a mobile body, a mobile body itself, or the like. The mobile body may be a vehicle (for example, a car, an airplane, or the like), an unmanned body that moves (for example, a drone, an autonomous car or the like), or a robot (manned type or unmanned type). At least one of the base station and the mobile station includes a device which need not move during a communication operation. For example, at least one of the base station and the mobile station may be an Internet of Things (IoT) device such as a sensor.

Furthermore, the base station in the present disclosure may be replaced with a user terminal. For example, each aspect/embodiment of the present disclosure may be applied to a configuration in which communication between the base station and the user terminal is replaced with communication between a plurality of user terminals (for example, which may be referred to as Device-to-Device (D2D) or Vehicle-to-Everything (V2X)). In this case, the user terminal 20 may have the functions of the terminal 20 described above. Furthermore, the terms “uplink” and “downlink” may be replaced with terms corresponding to inter-terminal communication (for example, “side”). For example, an uplink channel, a downlink channel, or the like may be replaced with side channels. Similarly, the user terminal in the present disclosure may be replaced with the base station. In this case, the terminal 20 may have the functions of the above-mentioned user terminal 20.

Terms “connected,” “coupled,” or variations thereof means any direct or indirect connection or coupling between two or more elements and may include the presence of one or more intermediate elements between two elements which are “connected” or “coupled.” The coupling or the connection between the elements may be physical, logical, or a combination thereof. For example, “connection” may be replaced with “access.” In a case in which used in the present disclosure, two elements may be considered to be “connected” or “coupled” with each other using at least one of one or more electric wires, cables and/or a printed electrical connection or using electromagnetic energy having a wavelength in a radio frequency domain, a microwave region, or a light (both visible and invisible) region as non-limiting and non-exhaustive examples.

A reference signal may be abbreviated as RS (Reference Signal) and may be referred to as a pilot, depending on a standard to be applied.

A phrase “based on” used in the present disclosure is not limited to “based only on” unless otherwise stated. In other words, a phrase “based on” means both “based only on” and “based on at least.”

In a case in which “include,” “including,” and variations thereof are used in the present disclosure, these terms are intended to be comprehensive, similar to a term “provided with (comprising).” Further, the term “or” used in the present disclosure is intended not to be an exclusive OR.

In the entire present disclosure, for example, when an article such as “a,” “an,” or “the” in English is added by a translation, the present disclosure may include a case in which a noun following the article is the plural.

In the present disclosure, a term “A and B are different” may mean “A and B are different from each other.” Furthermore, the term may mean “each of A and B is different from C.” Terms such as “separated,” “coupled,” or the like may also be interpreted similar to “different.”

Although the present invention is described above in detail, it is obvious to those skilled in the art that the present invention is not limited to the embodiments described in the specification. The present invention may be implemented as revised and modified embodiments without departing from the gist and scope of the present invention as set forth in claims. Accordingly, the description of the specification is for the purpose of illustration and does not have any restrictive meaning to the present invention.

### LIST OF REFERENCE SYMBOLS

10 base station

110 transmitting unit

120 receiving unit

130 control unit

20 terminal

210 transmitting unit

220 receiving unit

230 control unit

1001 processor

1002 storage device

1003 auxiliary storage device

1004 communication device

1005 input device

1006 output device

1. A terminal comprising:
a receiving unit that receives configuration information regarding puncturing of a downlink subcarrier of a first Radio Access Technology (RAT) among a plurality of supported RATs; and
a control unit that configures a number of one or more outlying subcarriers of the first RAT and a position of the one or more outlying subcarriers of the first RAT in a frequency domain based on the configuration information and configures a reception frequency band of a downlink carrier of the first RAT by puncturing a frequency band of the one or more outlying subcarriers.

2. The terminal according to claim 1, wherein, in a case where the configuration information includes information indicating that a downlink transmission band of the first RAT is semi-statically allocated, the control unit configures, as the reception frequency band of the downlink carrier of the first RAT, a semi-static reception frequency band obtained by puncturing the frequency band of the one or more outlying subcarriers, and
wherein, in a case where the configuration information includes information indicating that the downlink transmission frequency band of the first RAT is dynamically allocated, the control unit dynamically configures, as the reception frequency band of the downlink carrier of the first RAT, a reception frequency band obtained by puncturing the frequency band of the one or more outlying subcarriers.

3. The terminal according to claim 2, wherein the receiving unit receives, as the configuration information, configuration information of each narrow band of a plurality of narrow bands included in a frequency band of the downlink carrier of the first RAT,
wherein, for each narrow band of the plurality of narrow bands, when the configuration information of the narrow band includes information indicating that the downlink transmission frequency band of the first RAT is semi-statically allocated, the control unit configures, as the reception frequency band of the downlink carrier of the first RAT in the narrow band, a semi-static reception frequency band obtained by puncturing the frequency band of the one or more outlying subcarriers, and
wherein, when the configuration information of the narrow band includes information indicating that the downlink transmission frequency band of the first RAT is dynamically allocated, the control unit dynamically configures, as the reception frequency band of the downlink carrier of the first RAT in the narrow band, a reception frequency band obtained by puncturing the frequency band of the one or more outlying subcarriers.

4. The terminal according to claim 3, wherein the configuration information includes information indicating a subcarrier spacing applied to a second RAT among the plurality of RATs,
wherein, for each narrow band of the plurality of narrow bands, when the configuration information of the narrow band includes information indicating that the downlink transmission frequency band of the first RAT is semi-statically allocated, the control unit configures, as the reception frequency band of the downlink carrier of the first RAT in the narrow band, a semi-static reception frequency band corresponding to the subcarrier spacing and obtained by puncturing the frequency band of the one or more outlying subcarriers, and
wherein, when the configuration information of the narrow band includes information indicating that the downlink transmission frequency band of the first RAT is dynamically allocated, the control unit dynamically configures, as the reception frequency band of the downlink carrier of the first RAT in the narrow band, a reception frequency band corresponding to the subcarrier spacing and obtained by puncturing the frequency band of the one or more outlying subcarriers.

5. A communication method executed by a terminal, the method comprising:
receiving configuration information regarding puncturing of a downlink subcarrier of a first Radio Access Technology (RAT) among a plurality of supported RATs; and
configuring a number of one or more outlying subcarriers of the first RAT and positions of the one or more outlying subcarriers of the first RAT in a frequency domain based on the configuration information and configuring a reception frequency band of a downlink carrier of the first RAT by puncturing a frequency band of the one or more outlying subcarriers.
